(19) United States
(12) Patent Application Publication
(10) Pub. No.: US 2010/0248973 A1
(43) Pub. Date: Sep. 30, 2010

(54) MICROELECTRONIC SENSOR DEVICE WITH AN ARRAY OF DETECTION CELLS

(75) Inventors: Petrus J.W. Van Lankvelt, Eindhoven (NL); Jeroen H. Nieuwenhuis, Eindhoven (NL); Hans Van Zon, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/679,498

(22) PCT Filed: Sep. 19, 2008
(86) PCT No.: PCT/IB2008/053813

§ 371 Date: May 28, 2010

(30) Foreign Application Priority Data
Sep. 24, 2007 (EP) 07117080.7

(51) Int. Cl. C40B 30/00; C40B 60/12

(52) U.S. Cl. 506/7; 506/39

(57) ABSTRACT

The invention relates to a microelectronic sensor device with a matrix array of rows (R4, R5) and columns (C1, C2) of detection cells (10), wherein each detection cell comprises an activation element (30) for transferring target particles (e.g. magnetic beads) into an activated state and a sensor element (20) for detecting activated target particles. According to a preferred embodiment, the activation elements (20) of each row of the matrix as well as the sensor elements (20) of each column of the matrix are connected in series. By activating one row and reading out one column, each detection cell (10) can thus individually be addressed with a limited number of column- and row-address circuits.

The invention relates to a microelectronic sensor device with a matrix array of detection cells for detecting target particles at a contact surface. Moreover, it relates to the use of such a device.

The U.S. Pat. No. 6,736,978 B1 discloses a method and an apparatus for manipulating and monitoring a sample fluid comprising magnetic particles. The device comprises fluid channels under which a matrix array of GMR (Giant Magneto Resistance) elements is disposed for sensing magnetic fields induced by the streaming sample fluid. All GMR elements are electrically coupled in series and combined with a magnetic coil extending also in the plane of the sensors.

Moreover, a magnetic sensor device is known from the WO 2005/010543 A1 and WO 2005/010542 A2 (which are incorporated into the present application by reference) which may for example be used in a microfluidic biosensor for the detection of molecules, e.g. biological molecules, labeled with magnetic beads. The magnetic sensor device is provided with an array of sensor units comprising wires for the generation of a magnetic field and Giant Magneto Resistances (GMR) for the detection of stray fields generated by magnetized beads. The signal of the GMRs is then indicative of the number of the beads near the sensor unit.

Based on this situation it was an object of the present invention to provide a new design of a sensor device with a plurality of cells that allows for a flexible microelectronic integration and an implementation in a cost-effective way.

This objective is achieved by microelectronic sensor device according to claim 1 and a use according to claim 15. Preferred embodiments are disclosed in the dependent claims.

The microelectronic sensor device according to the present invention comprises a matrix array of rows and columns of detection cells for detecting target particles at a contact surface. It is characterized in that each detection cell comprises
at least one “sensor element” for providing a detection signal that corresponds to target particles which assume some activated state, and
at least one “activation element” for transferring target particles into said activated state.

Moreover, the activation elements in each row of the matrix array are connected in an associated row-access circuit with a common row-access contact, and the sensor elements in each column of the matrix array are connected in an associated column-access circuit with a common column-access contact. The microelectronic sensor device further comprises
a control unit for selectively accessing row-access circuits via the associated row-access contact, and
a readout unit for selectively accessing column-access circuits via the associated column-access contact.

In the context of the present invention, the term “array” shall denote any arbitrary one-, two- or three-dimensional arrangement of a plurality of units called “cells”. Typically such an array will be two-dimensional and preferably planar, and its cells will optionally be arranged in a regular pattern, for example a grid pattern.

Moreover, the “matrix” feature of the array shall refer to the logical or functional (not necessarily geometrical) assignment of the cells of the array to a limited number of disjunct sets called “rows” and another limited number of disjunct sets called “columns”, wherein each cell belongs to one and only one row as well as to one and only one column such that it can be characterized by two numbers representing its row-index and column-index, respectively. As for a matrix of numbers known from mathematics, typically all rows have the same number of cells, and also all columns have the same numbers of cells. Usually the logical matrix organization will correspond to a geometrical matrix arrangement of the detection cells in a regular, rectangular grid pattern. It should be noted that the terms “row” and “column” are interchangeable here, i.e. the activation elements could as well be assigned to “columns” and the sensor elements to “rows”.

The mentioned “target particles” may particularly comprise a combination of target components (e.g. biological substances like biomolecules, complexes, cell fractions or cells) and “label particles” (e.g. atoms, molecules, complexes, nanoparticles, microparticles etc.) that have some property (e.g. optical density, magnetic susceptibility, electric charge, fluorescence, or radioactivity) which can be detected.

The “contact surface” will usually be the interface between a substrate of the sensor device and a sample which comprises the target particles to be detected.

Furthermore, the “detection” of target particles will correspond to any process that quantitatively or qualitatively senses some characteristic parameter of the target particles, e.g. their mass, charge, magnetic moment, absorption coefficient etc. In many cases, the detection shall just provide the information that a target particle is in a given sensitive volume to allow the estimation of the total number or the concentration of target particles in said volume.

The transfer of a target particle into an “activated state” by an activation element will usually be transient, i.e. the target particle will return to a non-activated state after some time and/or after the activity of the activation element has stopped.

Moreover, the reach of the activation element and/or of the sensor element will typically be restricted to nearby target particles such that each detection cell has an associated sensitivity volume at the contact surface in which its activation element can activate target particles and/or its sensor element can detect activated target particles. Preferably, the sensitivity volumes of different detection cells do not or only minimally overlap.

The control unit and/or the readout unit may be realized by dedicated (analogue) electronic hardware, digital data processing hardware with associated software, or a mixture of both.

Finally, it should be noted that the incorporation of the activation elements in row-access circuits with a common row-access contact and of the sensor elements in column-access circuits with a common column-access contact shall imply that the incorporated elements have at least one terminal connected to these access circuits and that these connected terminals cannot be addressed or accessed from outside the array individually but only in common, via the associated common access contact. Moreover, the row-access contacts of different rows are usually electrically separated from each other, such that they can be supplied with different voltages (or float). Similarly, the column-access contacts of different columns are usually electrically separated from each other, too. The row-access and column-access circuits may optionally have further contacts (besides the row/column-access contact) that can be accessed from outside, particularly a ground contact.

The described microelectronic sensor device realizes an array of detection cells in which different activation elements and different sensor elements are incorporated into common access circuits. This saves a lot of space which would be required for routing individual lines to each activation/sensor element, thus allowing the design of microelectronic sensor devices with a large number of detection cells.

According to a first particular layout of row-access circuits in the microelectronic sensor device, the activation elements in each row are connected in series, thus making up the associated row-access circuit. This means that the activation elements are part of the row-access circuit, wherein each activation element comprises a first and a second terminal, with the latter being connected to the first terminal of the subsequent activation element. If an electrical current is sent through the row-access circuit, this current will therefore flow through each activation element of the corresponding row.

According to a first particular layout of column-access circuits in the microelectronic sensor device, the sensor elements in each column are connected in series, thus making up the associated column-access circuit. This means that the sensor elements are part of the column-access circuit, wherein each sensor element comprises a first and a second terminal, with the latter being connected to the first terminal of the subsequent sensor element. Due to the “connection in series”, the detection signal of the sensor elements is passed along the column from one sensor element to the neighboring one until it reaches some interface terminal (usually the column-access contact) at the border of the matrix array. Typically, the detection signals of the sensor elements of each column will be superimposed (added) during this traveling process, resulting for example in a single electrical output voltage with indistinguishable contributions of the individual sensor elements. If an electrical current is sent through the column-access circuit, this current will flow through each sensor element of the corresponding column.

When the aforementioned two layouts are combined, an array of detection cells is realized that is organized in rows of commonly addressable activation elements and columns of commonly readable sensor elements. This organization has the advantage that the detection process can individually take place for each detection cell by (i) activating the row of activation elements to which said detection cell belongs and (ii) reading out the corresponding column of sensor elements to which said detection cell belongs. Though all target particles above detection cells in the addressed row will be transferred to an activated state in this case, only the target particles that are at the same time above the read-out column will be detected, thus effectively limiting the detection process to the sensitivity volume of the detection cell of interest. Another advantage of the design is that only the rows and columns have to be addressed, not each detection element individually. In a matrix array with n rows and m columns, only the comparatively small number of (n+m) rows and columns must therefore be accessible to be able to address each of n×m detection cells individually. In a microelectronic sensor design, the number of external terminals or contact pads can thus be kept in reasonable ranges.

In a preferred embodiment of the microelectronic sensor device, the sensor elements of the columns are connected by electrical conductors. Thus a connection is achieved that can readily be realized in a microelectronic device and that can pass and add up electrical detection signals (e.g. voltages or voltage drops). Another advantage of the electrical conductors is that they can be crossed by other electrical lines (e.g. lines that connect the activation elements) without a high risk of undesirable crosstalk.

According to a second basic layout of the microelectronic sensor device, the activation elements in each column are connected to a common “column-output line”, and the sensor elements in each row are connected to a common “row-output line”.

In the usual case that the activation elements have two terminals, a first of these terminals can be connected to a common line of the associated row-access circuit while the second terminal is connected to the associated column-output line. A voltage that is applied between said common line of the row-access circuit and said column-output line will therefore be directly present at the two terminals of the activation element in the associated row and column.

Similarly, if the sensor elements have as usual two terminals, a first of these terminals can be connected to a common line of the associated column-access circuit while the second terminal is connected to the associated row-output line. A voltage that is applied between said common line of the column-access circuit and said row-output line will therefore be directly present at the two terminals of the sensor element in the associated row and column.

As a result, a direct access to the terminals of an activation element or sensor element can be achieved via the associated access contacts and output lines.

It should be noted that, depending on the exact routing of lines in the matrix array of detection cells, the aforementioned voltages may spread to other activation/sensor elements, too. However, a direct application of the voltage is usually only achieved for the terminals of the activation/sensor element in the correct row and column.

It should further be noted that the term “output” in the context of the row/column output lines is primarily chosen as unique reference name and does not imply any restrictive assumption as to the design of functionality of these lines.

According to a further development of the aforementioned embodiment, the control unit is adapted for selectively accessing the mentioned column-output lines. By addressing both a particular row-access circuit and a particular column-output line, the control unit can then selectively access the individual activation element in the associated row and column.

In another further development of the above embodiment, the readout unit is adapted for selectively accessing the mentioned row-output lines. By addressing both a particular column-access circuit and a particular row-output line, the readout unit can then selectively access the individual sensor element in the associated row and column.

The contact surface at which detection takes place is preferably at least partially covered with binding sites for target particles. The “binding sites” may be any devices that achieve the desired binding of target particles, for example conductor wires that can attract target particles by magnetic or electrical forces. Preferably, the binding sites comprise capture molecules that can specifically bind to certain target particles. Such capture molecules are often used in bioassays to specifically select with antibody-antigen combinations certain molecules of interest from a complex biochemical mixture (e.g. blood or saliva). Thus both an immobilization of the target particles at the contact surface as well as a specificity to certain molecules can be achieved.

The binding sites may cover the contact surface uniformly or non-uniformly. In the latter case, at least one type of binding sites may for example be present on the contact surface with varying density (e.g. present above certain detection cells and absent elsewhere). Using various types of binding sites, different parts of the contact surface can be made sensitive for different types of target particles.

The sensor device may further optionally comprise a manipulation device for actively moving target particles. The manipulation device may particularly comprise a magnetic field generator, e.g. an electromagnet, for exerting magnetic forces (via field gradients) on magnetic target particles. The manipulation may for example be used to move target particles in an accelerated way to the contact surface.

According to another embodiment of the invention, the sensor device comprises an evaluation unit for evaluating the detection signals of the sensor elements. The evaluation unit may be realized by dedicated (analogue) electronic hardware, digital data processing hardware with associated software, or a mixture of both. The particular realization of the evaluation process depends on the type of detection signals that are provided by the sensor elements and the information one is interested in. Thus the detection signals may for example represent the magnitude of magnetic fields generated by magnetized target particles, which is evaluated with respect to the concentration of target particles at the contact surface of the considered detection cell. Preferably, the detection signals are (inter alia) evaluated with respect to inhomogeneities of the spatial distribution of target particles, which may sometimes inadvertently occur (e.g. by an insufficient mixing of labels with a sample or a non-uniform attachment to the surface of binding-sites) and which may lead to erroneous results. By detecting such inhomogeneities and by taking them into account, more accurate detection results can be achieved.

Depending on the type of target particles that shall be detected, the activation elements and the sensor elements may take many different forms. Thus the activation elements may for example be ultrasonic emitters, or light sources that illuminate target particles to provoke effects of fluorescence, absorption, scattering, frustrated total internal reflection or the like. In a preferred embodiment, at least one activation element of the sensor device comprises a magnetic field generator, for example a conductor wire or a plurality of conductor wires, which can induce a magnetic dipole moment in magnetizable target particles to generate a stray field that can be detected. Magnetic field generators like the mentioned conductor wires will typically be activated by passing an electrical current through them. Such activation elements can therefore readily be coupled by simply connecting them electrically in series.

The sensor element may be or comprise any sensitive unit that is suited for sensing a parameter of interest of a target particle to be detected. Preferably, the sensor device comprises an optical, magnetic, mechanical, acoustic, thermal and/or electrical sensor element. A magnetic sensor element may particularly comprise a coil, Hall sensor, planar Hall sensor, flux gate sensor, SQUID (Superconducting Quantum Interference Device), magnetic resonance sensor, magneto-restrictive sensor, or magneto-resistive sensor of the kind described in the WO 2005/010543 A1 or WO 2005/010542 A2, especially a GMR (Giant Magneto Resistance), a TMR (Tunnel Magneto Resistance), or an AMR (Anisotropic Magneto Resistance). An optical sensor element may particularly be adapted to detect variations in an output light beam that arise from a frustrated total internal reflection due to target particles at a sensing surface. Other optical, mechanical, acoustic, and thermal sensor concepts are described in the WO 93/22678, which is incorporated into the present text by reference.

In a preferred embodiment of the invention, the microelectronic sensor device comprises at least one sensor element that has one magneto-resistive strip or a plurality of parallel magneto-resistive strips. Preferably, several of these strips are arranged in an alternating sequence with conductor wires of an associated magnetic field generator of the kind described above. Thus a uniform magnetic activation and magnetic sensing can be achieved in the area of the considered detection cell.

In a further development of the aforementioned embodiment, the activation element comprises a conductor wire or a plurality of parallel conductor wires, said wire(s) running parallel to and/or in the same plane as the magneto-resistive strip. Preferably, at least two conductor wires are arranged symmetrically with respect to the magneto-resistive strip. The effects that magnetic fields, which are generated by a current flowing through the conductor wire(s), have on the magneto-resistive strip can in this design be minimized, reserving the sensitivity of the strip for magnetic fields of interest.

The invention further relates to the use of the microelectronic sensor device described above for molecular diagnostics, biological sample analysis, or chemical sample analysis, food analysis, and/or forensic analysis. Molecular diagnostics may for example be accomplished with the help of magnetic beads or fluorescent particles that are directly or indirectly attached to target molecules.

These and other aspects of the invention will be apparent from and elucidated with reference to the embodiment(s) described hereinafter. These embodiments will be described by way of example with the help of the accompanying drawings in which:

FIG. 1 shows a top view of a microelectronic sensor device according to the present invention with a matrix array of magnetic excitation wires and GMR sensors;

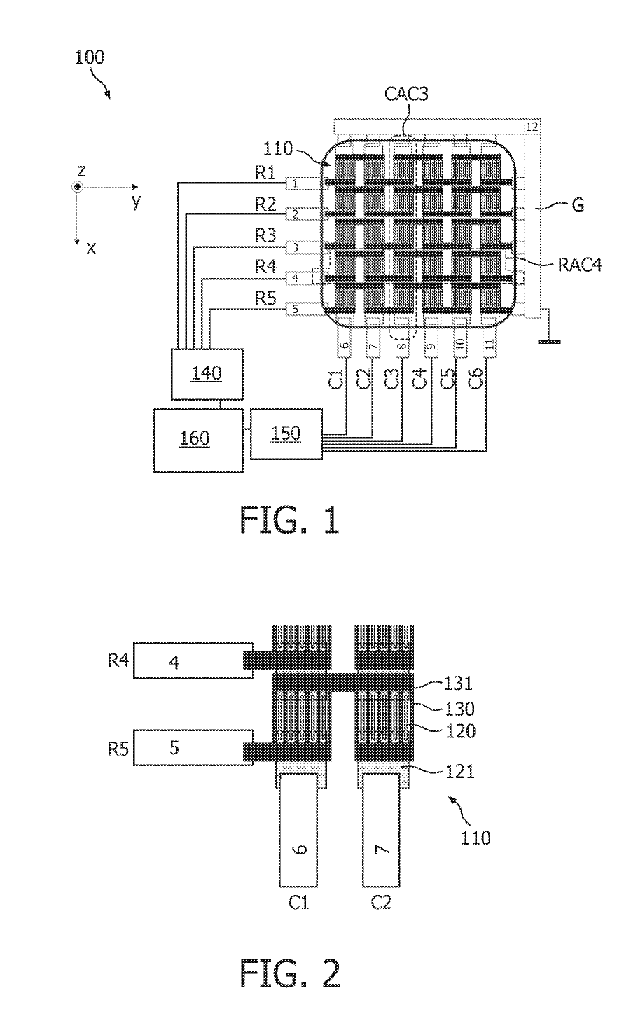

FIG. 2 shows an enlarged view of two detection cells of the sensor device of FIG. 1;

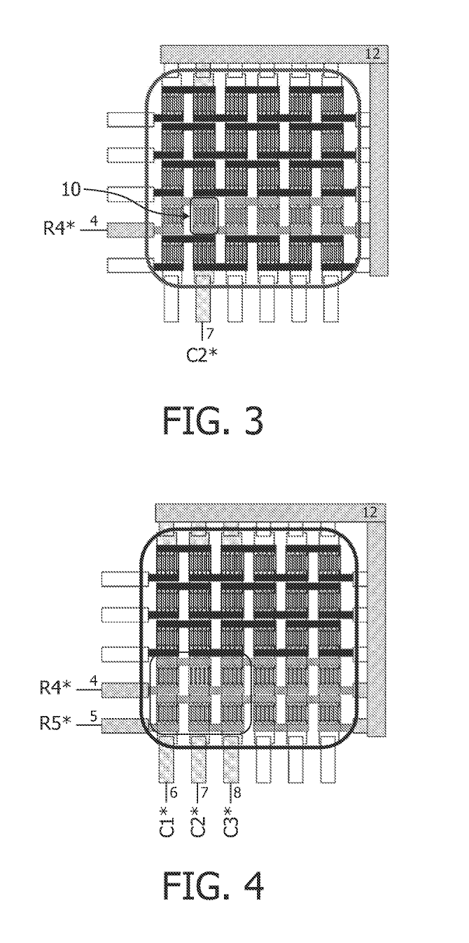

FIG. 3 illustrates the addressing of a single detection cell;

FIG. 4 illustrates the addressing of a sub-matrix of detection cells;

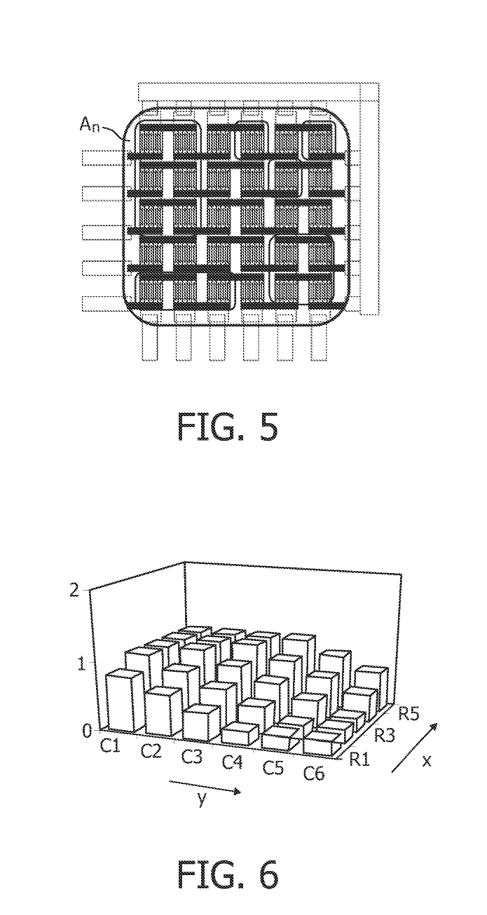

FIG. 5 illustrates the provision of regions with different specificity for target particles;

FIG. 6 illustrates a measured inhomogeneous distribution of target particles across the sensor surface;

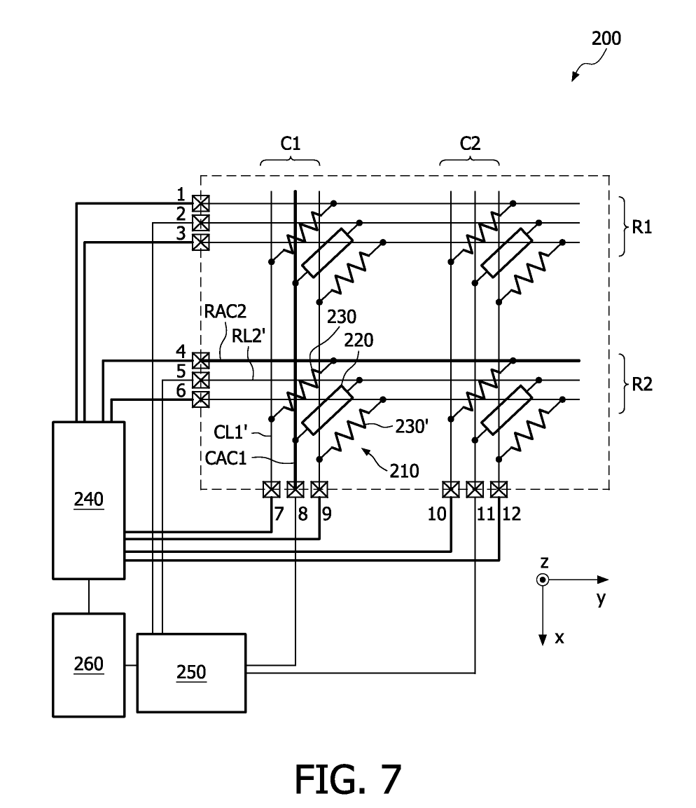

FIG. 7 shows four detection cells of a microelectronic sensor device according to another embodiment of the present invention, in which magnetic excitation wires and GMR sensors are coupled to access lines and output lines running across the rows and columns.

Like reference numbers or numbers differing by integer multiples of 100 refer in the Figures to identical or similar components.

The invention will in the following be explained with respect to magneto-resistive biochips, though it is not restricted to this realization. Magneto-resistive biochips have promising properties for bio-molecular diagnostics, in terms of sensitivity, specificity, integration, ease of use, and costs. A biosensor comprising an array of (e.g. 25) sensor elements, based on the detection of super paramagnetic beads, may be used to simultaneously measure the concentration of a large number of different (biological) molecules (e.g. protein, DNA, drugs of abuse) in a solution (e.g. blood). There are many different applications possible with this technique and based on the number of different tests per cartridge/chip, each application needs a unique chip layout. In order to keep the costs as low as possible, a chip layout is proposed here which can be used for all different applications.

FIG. 1 shows schematically a top view onto an exemplary embodiment of the proposed microelectronic sensor device 100 which comprises a matrix array of n=5 rows R1, R2, . . . R5 and m=6 columns C1, C2, . . . C6 of “detection cells” 110. As the enlarged view of FIG. 2 shows, each detection cell 110 comprises
A sensor element consisting of a number of (e.g. five) parallel stripes of GMR (Giant Magneto Resistance) elements 120 connected at their ends to metal conductors 121 that electrically connect neighboring sensor elements of the same column to each other and to external contact pads, respectively.
An “activation element”, realized by a set of (e.g. six) parallel conductor wires 130 that are arranged parallel to each other and in an alternating sequence with the GMR elements 120. The conductor wires 130 are connected at their ends to metal conductors 131 which electrically connect neighboring sets of conductor wires 130 of the same row to each other and to external contact pads, respectively.

It should be noted that the GMR elements 120 with their electrical connections 121 and the conductor wires 130 with their electrical connections 131 are electrically isolated from each other. All conductor wires 130 of the same row Rx are connected in series as a “row-access circuit” (e.g. RAC4 in FIG. 1) with an associated common “row-access contact” (e.g. pin 4 for RAC4). The row-access circuits are connected via the associated row-access contacts (pins 1-5) to a control unit 140 and further connected to a common ground electrode G; thus they can be supplied with the same excitation current.

Similarly, all GMR elements 120 of the same column Cx are connected in series as a “column-access circuit” (e.g. CAC3 in FIG. 1) with an associated common “column-access contact” (e.g. pin 8 for CAC3). The column-access circuits are connected via the associated column-access contacts (pins 6-11) to a readout unit 150 and further connected to a common ground electrode G; thus they can be supplied with the same sensing current. The control unit 140 and the readout unit 150 are in turn connected to an evaluation unit 160, e.g. a digital data processor, where higher-level control and data evaluation takes place. The control unit and/or the readout unit will typically be integrated onto the same chip as the array of detection cells 110.

During operation, an electrical excitation current is sent by the control unit 140 through the conductor wires 130, which generate a magnetic excitation field at the contact surface and in the nearby sample fluid above the sensor area (i.e. in z-direction above the drawing plane of FIGS. 1 and 2). Magnetizable target particles in the sample, e.g. biomolecules labeled with superparamagnetic beads, will then be magnetized by the excitation field. The resulting magnetic stray fields of the magnetized target particles will induce a resistance change in the GMR elements 120, which can be sensed as an associated voltage drop if a sensing current is sent through the GMR elements by the readout unit 150. For more details on this magnetic sensor principle, reference is made to the WO 2005/010542 and WO 2005/010543.

An essential feature of the proposed sensor design is the matrix of GMR lines 120 and conductor wires 130, which form individually addressable magnetic detection cells 110 (biosensors) at each matrix element. By connecting only one side of the matrix to separate pins and connecting the other side to a shared ground pin, one can create a high number of individual addressable sensors with a low number of pins. When the matrix consists of n·m detection cells 110, the number of pins required is only (n+m+1). This means that for a chip with 32 pins the maximum number of individually addressable sensors is 240. FIG. 1 shows as an example a chip layout using 12 pins; pins number 1 to 5 are “row-access contacts” for the excitation current lines 130, pins number 6 to 11 are “column-access contacts” for the GMR lines 120. Pin number 12 is a ground pin G, which is connected to all matrix lines.

A major advantage of the design is the high number of detection cells per chip. This makes it possible to produce a sort of uniform chip layout that can be used for many different assays/applications.

The close-up of two detection cells 110 of FIG. 2 clearly shows that the excitation current conductor wires 130 are locally parallel to the GMR lines 120 and preferably also arranged in a common plane with them. To prevent high cross-talk signals at the locations where the current wires and the GMR lines cross, the GMR lines are interrupted and connected with metal conductors 121 between the rows.

The matrix connection scheme can be used to read out individual detection cells (matrix elements) as illustrated in FIG. 3 for the detection cell 110 in row R4 and column C2. To read the signal from this detection cell 110, a current source is connected by the control unit 140 to pin 4 (=R4) and pin 12 (=ground G), and the signal is read out by the readout unit 150 between pins 7 (=C2) and 12 (this addressing of a row or column is indicated in the Figures by an asterisk).

FIG. 4 illustrates the similar read-out of six sensors in rows R4, R5 and columns C1, C2, C3 which are acting as one bigger sensor, e.g. for improving the counting statistics of the signal.

Moreover, FIG. 5 illustrates a combination of sensor areas Aₙ which are coated with different binding sites for different target molecules. Depending on the sensitivity and the binding capacity a small or large sensor area can be used. In particular, the complete surface can be used acting as one big sensor for very hard and sensitive assays.

Another aspect that can be addressed with the proposed sensor design relates to a non-uniform distribution of magnetic beads (target particles) over the sensor surface, which can have a large effect on the outcome of the measurement. Such a non-uniform target particle distribution can be caused by several reasons, e.g.
misalignment of an attraction coil (not shown) with respect to the sensor surface;
a non-uniform initial distribution of magnetic beads, for example caused by the redispersion process of stored magnetic beads;
non-uniform attachment of binding-sites to the surface.

Tracking the target particle concentration at the surface during the attraction phase is a manner to spot non-uniformity and correct the measurement for it afterward. The local concentration can be measured by adding sensors that are sensitive for the unbound beads into the sensor matrix. This requires a sensor surface covered with small and individual addressable sensors such as disclosed here. FIG. 6 shows an example of a possible sensor signal (bead) distribution over the sensor array, which indicates clearly a non-uniform bead distribution. In this example the alignment of the attraction coil is not optimal and is more located in the upper left corner of the sensor surface with respect to the Figure. The surface concentration tracking gives the possibility to correct the end-point signal for it.

FIG. 7 shows four exemplary detection cells 210 of a matrix array of rows R1, R2, . . . and columns C1, C2, . . . of detection cells in an alternative microelectronic sensor device 200. Each detection cell comprises two parallel conductor wire 230, 230′ serving as magnetic field generators and, running parallel and in the same plane between them, a GMR strip 220 serving as magnetic sensor element. The following routing principles are applied:
In each column, a first terminal of each GMR strip 220 is connected to a common “column-access circuit” (cf. CAC1) with an associated single “column-access contact” (pins 8, 11).
In each row, a second terminal of each GMR strip 220 is connected to a common “row-output line” (cf. RL2′; associated pins: 2, 5).
In each row, a first terminal of each first conductor wire 230 is connected to a common “row-access circuit” (cf. RAC2) with an associated single “row-access contact” (pins 1, 4).
In each column, a second terminal of each first conductor wire 230 is connected to a common “column-output line” (cf. CL1′; associated pins: 7, 10).

The second conductor wires 230′ are similarly connected to row-access circuits and column-output lines of their own. Alternatively, they might be connected in parallel to the first conductor wires 230 to the same row-access circuits and column-output lines as these.

By supplying with a control unit 240 a voltage to a particular row-access circuit (e.g. RAC2, pin 4) and column-output line (e.g. CL1′, pin 7), this voltage can directly be applied to the conductor wire 230 in the associated row and column.

Similarly, by supplying with a readout unit 250 a voltage to a particular column-access circuit (e.g. CAC1, pin 8) and row-output line (e.g. RL2′, pin 5), this voltage can directly be applied to the GMR strip 220 in the associated row and column.

It should be noted that the mentioned voltages will reach in the matrix array also other conductor wires and GMR strips besides the ones in the addressed row and column; however, in these cases several wires/strips will lie in series, leading to a considerable reduction of resulting signals.

A main advantage of the microelectronic sensor device 200 is that it is very power-efficient. A problem arises however from the fact that besides by the desired detection cell signal is also contributed by the other detection cells (at significantly lower amplitude). This problem can be solved by combining in an evaluation procedure all data-points (acquired by addressing each detection cell 210). For a matrix of n rows and m columns one thus has n×m equations to solve for n×m unknowns. Thus one can still uniquely reconstruct the amount of signal for each detection cell.

In summary, a general biosensor layout is disclosed that can be used for many different applications. The flexible chip layout that consists of a matrix of individually addressable detection cells can reduce the costs of specific and low volume tests dramatically. Major advantages of the disclosed matrix topology are:
Possibility of correction for a non-uniform bead distribution, resulting in a robust sensor.
High number of individual addressable sensors with a very low number of connections.
With one and the same sensor the number of analytes can be varied from one to n·m, while always using the entire sensor surface; additionally the number of detection cells per analyte can be varied depending on the requirements of the assay.

While the invention was described above with reference to particular embodiments, various modifications and extensions are possible, for example:
The sensor element can be any suitable sensor to detect the presence of target particles on or near to a sensor surface, based on any property of the particles, e.g. it can detect via magnetic methods, optical methods (e.g. imaging, fluorescence, chemiluminescence, absorption, scattering, surface plasmon resonance, Raman, etc.), sonic detection (e.g. surface acoustic wave, bulk acoustic wave, cantilever, quartz crystal etc), electrical detection (e.g. conduction, impedance, amperometric, redox cycling), etc.
In case a magnetic sensor is used, this can be any suitable sensor based on the detection of the magnetic properties of the particle on or near to a sensor surface, e.g. a coil, magneto-resistive sensor, magneto-restrictive sensor, Hall sensor, planar Hall sensor, flux gate sensor, SQUID, magnetic resonance sensor, etc.
In addition to molecular assays, also larger moieties can be detected with sensor devices according to the invention, e.g. cells, viruses, or fractions of cells or viruses, tissue extract, etc.
The detection can occur with or without scanning of the sensor element with respect to the sensor surface.
Measurement data can be derived as an end-point measurement, as well as by recording signals kinetically or intermittently.
The particles serving as labels can be detected directly by the sensing method. As well, the particles can be further processed prior to detection. An example of further processing is that materials are added or that the (bio)chemical or physical properties of the label are modified to facilitate detection.
The device and method can be used with several biochemical assay types, e.g. binding/unbinding assay, sandwich assay, competition assay, displacement assay, enzymatic assay, etc. It is especially suitable for DNA detection because large scale multiplexing is easily possible and different oligos can be spotted via ink jet printing on the optical substrate.
The device and method are suited for sensor multiplexing (i.e. the parallel use of different sensors and sensor surfaces), label multiplexing (i.e. the parallel use of different types of labels) and chamber multiplexing (i.e. the parallel use of different reaction chambers).
The device and method can be used as rapid, robust, and easy to use point-of-care biosensors for small sample volumes. The reaction chamber can be a disposable item to be used with a compact reader, containing the one or more field generating means and one or more detection means. Also, the device, methods and systems of the present invention can be used in automated high-throughput testing. In this case, the reaction chamber is e.g. a well-plate or cuvette, fitting into an automated instrument.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. A microelectronic sensor device (100, 200) with a matrix array of rows (R1-R5) and columns (C1-C6) of detection cells (110, 210) for detecting target particles at a contact surface, wherein each detection cell (110, 210) comprises
at least one sensor element (120, 220) for providing a detection signal corresponding to the detection of target particles that assume some activated state, and
at least one activation element (130, 230) for transferring target particles into said activated state,
wherein the activation elements (130, 230) in each row (R1-R5) are connected in an associated row-access circuit (RAC4, RAC2) with a common row-access contact,
and wherein the sensor elements (120, 220) in each column (C1-C6) are connected in an associated column-access circuit (CAC3, CAC1) with a common column-access contact,
the microelectronic sensor device (100, 200) further comprising
a control unit (140, 240) for selectively accessing row-access circuits (RAC4, RAC2) via the associated row-access contact,
and a readout unit (150, 250) for selectively accessing column-access circuits (CAC3, CAC1) via the associated column-access contact.

2. The microelectronic sensor device (100) according to claim 1,
characterized in that the activation elements (130) in each row (R1-R5) are connected in series, thus making up the associated row-access circuit (RAC4).

3. The microelectronic sensor device (100) according to claim 1,
characterized in that the sensor elements (120) in each column (C1-C6) are connected in series, thus making up the associated column-access circuit (CAC3).

4. The microelectronic sensor device (100) according to claim 1,
characterized in that the sensor elements (120) of the columns (C1-C6) are connected by electrical conductors (121).

5. The microelectronic sensor device (200) according to claim 1,
characterized in that the activation elements (230) in each column (C1, C2) are connected to a common column-output line (CL1′),
and that the sensor elements (220) in each row (R1, R2) are connected to a common row-output line (RL2′).

6. The microelectronic sensor device (200) according to claim 5,
characterized in that the control unit (240) is adapted for selectively accessing the column-output lines (CL1′).

7. The microelectronic sensor device (200) according to claim 5,
characterized in that the readout unit (250) is adapted for selectively accessing the row-output lines (RL2′).

8. The microelectronic sensor device (100, 200) according to claim 1,
characterized in that the contact surface is uniformly or non-uniformly covered with binding sites for target particles.

9. The microelectronic sensor device (100, 200) according to claim 1,
characterized in that it comprises a manipulation device, particularly a magnetic field generator, for actively moving target particles.

10. The microelectronic sensor device (100, 200) according to claim 1,
characterized in that it comprises an evaluation unit (160, 260) for evaluating the detection signals of the sensor elements (120, 220), particularly with respect to inhomogeneities of the spatial distribution of target particles.

11. The microelectronic sensor device (100, 200) according to claim 1,
characterized in that at least one activation element comprises a magnetic field generator, particularly a conductor wire or a plurality of parallel conductor wires (130, 230, 230′).

12. The microelectronic sensor device (100, 200) according to claim 1,
characterized it comprises an optical, magnetic, mechanical, acoustic, thermal or electrical sensor element.

13. The microelectronic sensor device (100, 200) according to claim 1,
characterized in that the sensor element comprises at least one magneto-resistive strip (120, 220).

14. The microelectronic sensor device (100, 200) according to claim 13,
characterized in that at least one activation element comprises a conductor wire or a plurality of parallel conductor wires (130, 230, 230′) running parallel to and/or in the same plane as the magneto-resistive strip (120, 220).

15. Use of the microelectronic sensor device (100, 200) according to claim 1 for molecular diagnostics, biological sample analysis, or chemical sample analysis.
